(19) United States
(12) Patent Application Publication
(10) Pub. No.: US 2014/0337708 A1
(43) Pub. Date: Nov. 13, 2014

(54) METHOD AND APPARATUS FOR PROVIDING WEB BROWSING SERVICE

(71) Applicant: Samsung Electronics Co., Ltd., Suwon-si (KR)

(72) Inventors: Kyung-sun CHO, Seoul (KR); Young-il CHOI, Seoul (KR)

(73) Assignee: Samsung Electronics Co., Ltd., Suwon-si (KR)

(21) Appl. No.: 14/266,203

(22) Filed: Apr. 30, 2014

(30) Foreign Application Priority Data
May 9, 2013 (KR) 10-2013-0052756

(51) Int. Cl. G06F 17/22

(52) U.S. Cl. CPC G06F 17/2247
USPC 715/234

(57) ABSTRACT

A method of providing a web browsing service is provided. The method includes selecting an area of a web page that is requested by a client, converting Document Object Model (DOM) elements included in the area of the web page into an image, generating DOM data, the generated DOM data includes the image as a last node, and transmitting the DOM data to the client.

### CROSS-REFERENCE TO RELATED APPLICATION(S)

This application claims the benefit under 35 U.S.C. §119(a) of a Korean patent application filed on May 9, 2013 in the Korean Intellectual Property Office and assigned Serial number 10-2013-0052756, the entire disclosure of which is hereby incorporated by reference.

### TECHNICAL FIELD

The present disclosure relates to a method and apparatus for providing a web browsing service. More particularly, the present disclosure relates to a method of providing a web browsing service by using Document Object Model (DOM) data.

### BACKGROUND

Owing to the World Wide Web, users may share network data via the Internet. The users may obtain information (i.e. web pages and web content), from web servers in a network by using web browsers installed in clients.

The web browsers are software applications for retrieving Hyper Text Markup Language (HTML) documents from the web servers and displaying the HTML documents such that the users may read them. Examples of the web browsers include Microsoft Internet Explorer, Google Chrome, Apple Safari, Mozilla Firefox, Opera, Netscape, and the like.

A service for searching for information on the Internet via the web browsers is referred to as a web browsing service. In other words, the web browsing service may include processes performed by the clients to display the information (i.e., web pages), such as sending a request for the information to a web server and receiving the information.

The users may obtain or share necessary data by using the web browsing service. Due to the recent development of web related technology, the information (i.e., web pages), is quickly becoming more complex. Furthermore, there are various types of clients that may provide web browsing services by using different bandwidths and different capabilities such as resolution, display size, operating system, and web browser.

Therefore, it is necessary to provide web browsing services according to clients that use various web browsers and vary in performance.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for providing a web browsing service by using Document Object Model (DOM) data.

Additional aspects will be set forth in part in the description which follows and, in part, will be apparent from the description, or may be learned by practice of the presented embodiments.

In accordance with an aspect of the present disclosure, a method of providing a web browsing service is provided. The method includes selecting an area of a web page that is requested by a client, converting DOM elements included in the area of the web page into an image, generating DOM data, the generated DOM data includes the image is a last node, and transmitting the DOM data to the client.

In accordance with another aspect of the present disclosure, a method of providing a web browsing service is provided. The method includes receiving, from a server, DOM data that includes a node in which an area of a web page including a plurality of DOM elements is converted into an image, displaying the web page by using the DOM data, and requesting for additional DOM data that is configured of the DOM element, when a user's input that requests for a DOM element of the plurality of DOM elements is received.

In accordance with another aspect of the present disclosure, a server for providing a web browsing service is provided. The server includes an area selection unit configured to select an area of a web page that is requested by a client, a conversion unit configured to convert DOM elements included in the area of the web page into an image, a DOM data generation unit configured to generate DOM data, the generated DOM data includes the image as a last node, and a transmitter transmitting the DOM data to the client.

In accordance with another aspect of the present disclosure, a client for providing a web browsing service is provided. The client includes a receiver configured to receive, from a server, DOM data that includes a node in which an area of a web page including a plurality of DOM elements is converted into an image, a web page display unit configured to display the web page by using the DOM data, and a transmitter configured to request additional DOM data that is configured of the DOM element, when a user's input that requests for a DOM element of the plurality of DOM elements is received.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A, 1B, and 1C illustrate a general system for providing a web browsing service according to an embodiment of the present disclosure;

FIG. 2 illustrates a system for providing a web browsing service according to an embodiment of the present disclosure;

FIG. 3 is a flowchart of providing a web browsing service from a server according to an embodiment of the present disclosure;

FIG. 4 is a flowchart of providing a web browsing service from a client according to an embodiment of the present disclosure;

FIGS. 5A and 5B illustrate a structure of Document Object Model (DOM) data according to an embodiment of the present disclosure;

FIG. 6 is a flowchart of processing information for providing a web browsing service according to an embodiment of the present disclosure;

FIG. 7 illustrates a structure of the server providing a web browsing service according to an embodiment of the present disclosure; and

FIG. 8 illustrates a structure of a client providing a web browsing service according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

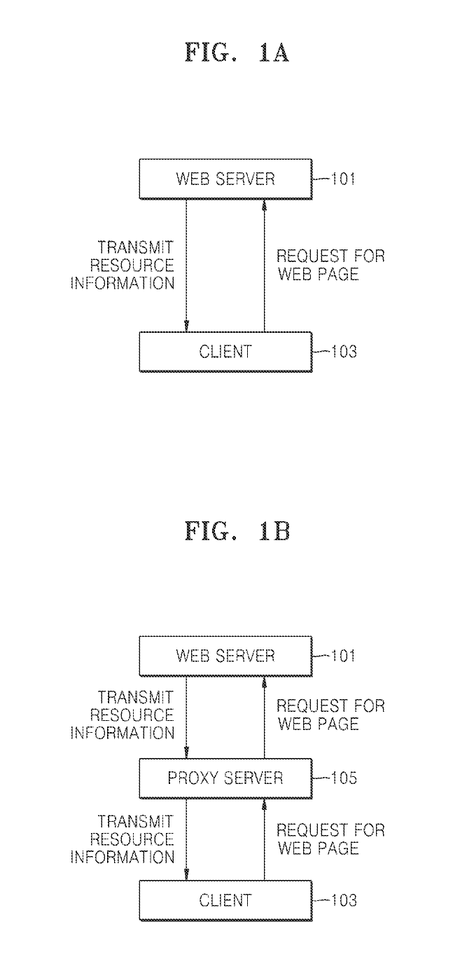

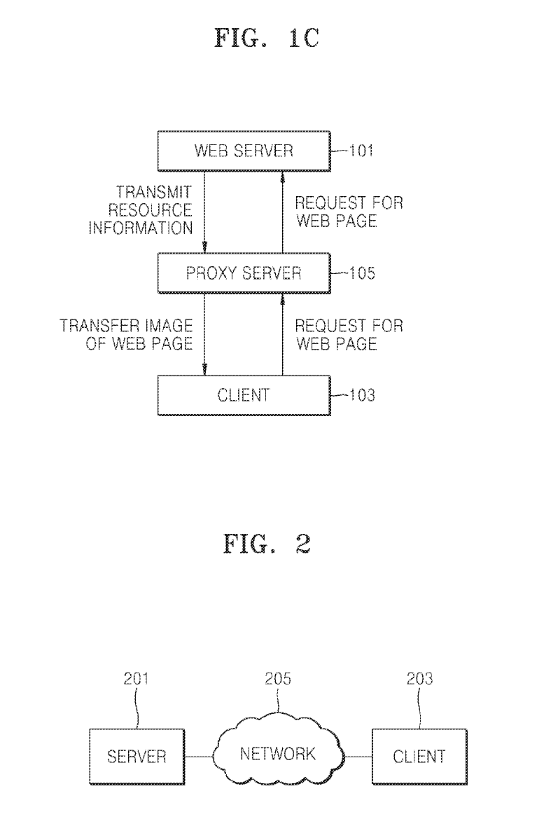

FIGS. 1A to 1C illustrate a general system for providing a web browsing service according to an embodiment of the present disclosure.

Referring to FIG. 1A, a client 103 may send a request to a web server 101 for information for displaying a web page so as to display the web page.

In detail, when a user's input is received, the client 103 sends a request to the web server 101 for the information for displaying the web page via a web browser installed in the client 103.

The web server 101 transmits resource information for displaying the web page via the web browser installed in the client 103 to the client 103.

The resource information for displaying the web page includes information that forms the web page (e.g., Hyper Text Markup Language (HTML), JAVA Script (JS), Cascading Style Sheets (CSS), and images). However, the resource information is not limited to the examples above.

The client 103 processes the resource information and thus displays the web page for the user.

However, due to the increase use of mobile devices and the development of communication technology, the number of clients and the number of web page requests have dramatically increased, thereby causing difficulty in processing every client request at a web server.

Referring to FIG. 1B, when it is difficult for the web server to process every client request, a proxy server 105 may be used to access the web server 101.

The proxy server 105 receives and stores the resource information from the accessed web server 101. When the client 103 requests for the resource information, the proxy server 105 independently processes the resource information so that data transmission time is reduced.

Various client devices have been developed along with the increase in mobile devices. Users use web browsing services by using mobile clients (e.g., mobile phones, Personal Digital Assistants (PDAs), and tablet PCs). In addition, thin clients and zero clients have been developed along with the development of a cloud network. The thin clients and the zero clients, which have no or small computing ability or rendering ability, are specialized for the cloud network.

However, due to the increasing complexity of web content and web pages, the thin client and the zero clients, which have no or small computing ability or rendering ability, and clients that have limited power supply, such as mobile phones, PDAs, and tablet PCs, may have difficulty in independently processing the web content.

Referring to FIG. 1C, the proxy server 105 may receive the resource information and generate Document Object Model (DOM) data by using the resource information. The proxy server 105 generates an image of the web page that is requested by the client 103 by using the DOM data and transfers the image to the client 103.

In this case however, when an additional user's input related to the web page is received, the additional user's input may not be independently processed by the client 103. Therefore, the client 103 has to send an additional request to the proxy server 105 for an image of the web page which includes the user's input, thereby reducing the speed of the web browsing service.

According to the various embodiments of the present disclosure, a method and apparatus for providing a web browsing service uses DOM data so that a client may process a user's input related to a web page without reducing the speed of the web browsing service.

FIG. 2 illustrates a system for providing a web browsing service according to an embodiment of the present disclosure.

Referring to FIG. 2, in the system according to an embodiment of the present disclosure, a client 203 and a server 201 may communicate via a network 205.

According to an embodiment of the present disclosure, the network 205 may include, but is not limited to, a wired network and a wireless network. In other words, the network 205 may include any type of network via which a client and a server may be connected.

According to an embodiment of the present disclosure, the client 203 may include, but is not limited to, a device such as a desktop, a laptop, a mobile phone, a PDA, and a tablet PC. In other words, the client 203 may include any type of client that may communicate via a network.

According to an embodiment of the present disclosure, the client 203 may include a program that may use the web browsing service (e.g., a web browser). Since the web browser is well-known to one of ordinary skill in the art, detailed description thereof will be omitted.

According to an embodiment of the present disclosure, in order to provide the web browsing service to the user, the client 203 may send a request to the server 201 for web content such as a web page or a web document. In response to the request from the client 203, the server 201 may provide DOM data to display the web page or the web document.

According to an embodiment of the present disclosure, the DOM data indicates a model of an object (i.e., a data group included in the web document). That is, the DOM data indicates a structure and elements of the web page or the web document displayed via the web browser. In general, the DOM data may have a hierarchical structure such as a tree structure.

According to an embodiment of the present disclosure, points in the tree structure are referred to as “nodes”. According to respective locations of the nodes, the nodes are classified into “parent nodes”, “child nodes”, “last nodes” (i.e., “leaf nodes”), and the like. Also, the nodes may be classified based on respective characteristics of elements located at the nodes. According to an embodiment of the present disclosure, the nodes may indicate points in the hierarchical structure of the DOM data, where predetermined DOM elements exist.

According to an embodiment of the present disclosure, the DOM data, which received from the server 201, may include a node in which an area of the web page that includes DOM elements is converted into an image.

According to an embodiment of the present disclosure, the DOM elements indicate elements that form the web page (e.g., images, text, links, fonts, frames, or flash). However, the DOM elements are not limited to the examples above.

According to an embodiment of the present disclosure, the server 201 may include a proxy server and a cloud server. That is, according to an embodiment of the present disclosure, the server 201 may not only function as a proxy server, but also as a cloud server.

According to an embodiment of the present disclosure, the proxy server is a server that functions as an intermediary between a client and a web server, which provides various functions such as a cache function, a firewall function, etc. Since the proxy server is well-known to one of ordinary skill in the art, detailed description thereof will be omitted. The cloud server is a server that stores data in a cloud network and allows cloud computing, and is connected to the client to provide various services including the web browsing service according to the various embodiments of the present disclosure.

According to an embodiment of the present disclosure, the server does not only indicate a single server, but also a plurality of servers that are connected to each other. For example, when a server among a plurality of groups of servers functions as a gateway and another server among the plurality of groups of servers processes data, the two servers may be included in the server according to the various embodiments of the present disclosure. In other words, the server according to the various embodiments of the present disclosure may include not only a single server, but also a group of servers.

According to an embodiment of the present disclosure, the server 201 may receive the request for the web page from the client 203 and receive resource information regarding the web page (hereinafter, referred to as “web page resource information”) from a web server (not shown). According to an embodiment of the present disclosure, when the web page resource information is cached in the server 201, it is not necessary to receive the web page resource information from the web server. The server 201 of FIG. 2 may function as the web server 101 of FIG. 1A.

According to an embodiment of the present disclosure, the server 201 may generate the DOM data by using the web page resource information received from the web server and transmit the generated DOM data to the client 203.

According to an embodiment of the present disclosure, the server 201 may select an area of the web page requested by the client 203, convert the area into an image, and thus, generate the DOM data.

According to an embodiment of the present disclosure, the server 201 may select the area of the web page requested by the client 203, convert the area into an image, and thus, generate the DOM data such that the converted image is a last node.

According to an embodiment of the present disclosure, from among a series of processes for displaying the web page, the generating of the DOM data uses the greatest amount of load. The server 201 may generate the DOM data of the web page and transmit the DOM data to the client 203 so as to prevent the client 203 from being overloaded. Also, by transmitting the DOM data to the client 203, the client 203 may process the user's input without sending an additional request to the server 201.

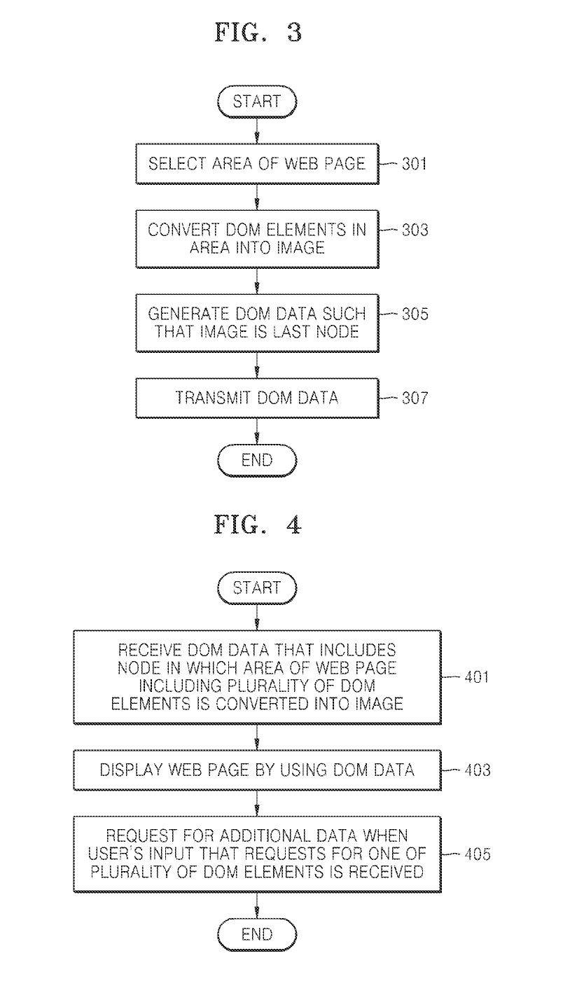

FIG. 3 is a flowchart of providing a web browsing service from a server according to an embodiment of the present disclosure.

Referring to FIG. 3, in operation 301, the server selects an area of a web page that is requested by a client.

According to an embodiment of the present disclosure, in order to display the web page based on a user's input, the client may send a request to the server for information for displaying the web page. The server may receive web page resource information from a web server and select an area of the web page that is requested by the client. That is, by receiving the web page resource information from the web server, the server may acquire every piece of information regarding the web page that is to be displayed in the client. Therefore, the server may select an area of the web page.

According to an embodiment of the present disclosure, the server may receive the web page resource information from the web server and render the web page based on the received web page resource information. The server may select an area of the web page according to a result of rendering of the web page.

According to an embodiment of the present disclosure, the server may receive the web page resource information from the web server and generate DOM data based on the received web page resource information. The server may select an area of the web page based on the generated DOM data.

According to an embodiment of the present disclosure, the server may determine whether or not information regarding the web page that is requested by the client is cached. If the information is cached in the server, the server does not have to receive the web page resource information from the web server. Also, if the information that is cached in the server is DOM data, the server may transmit the DOM data to the client.

According to an embodiment of the present disclosure, the server may receive the web page resource information from the web server and generate the DOM data based on the received web page resource information. The server may transmit the generated DOM data to the client. That is, the server may transmit DOM data, which does not include an area of the web page that is selected and converted into an image, to the client.

According to an embodiment of the present disclosure, the server may determine a priority of DOM elements in the web page, and select an area of the web page that is requested by the client according to a priority of selected DOM elements. In detail, the server may determine a priority of the DOM elements, and select an area of the web page such that the DOM elements are included starting from a DOM element having a low priority according to the priority of the DOM elements. As described above, according to an embodiment of the present disclosure, the DOM elements may indicate the elements that form the web page (e.g., images, text, links, fonts, or frames). However, the DOM elements are not limited to the examples above.

According to an embodiment of the present disclosure, along with the request for the web page by the client, the server may also receive at least one of performance information of the client and preference information of the client.

According to an embodiment of the present disclosure, the performance information of the client may include, but is not limited to, an Operating System (OS) installed in the client, a type of the web browser, model information of the client, graphic processing speed and graphic processing ability of the client, computing speed of the client, and memory information of the client.

According to an embodiment of the present disclosure, the preference information of the client may include information regarding which area of the web page or which DOM element from among the DOM elements in the web page is preferred by the user. That is, the client may store user history information regarding the web page.

According to an embodiment of the present disclosure, the user history information may refer to, for example, information regarding operations performed on the web page by the user, such as temporary files or cookies. Therefore, based on the operations performed on the web page by the user, the client may determine which DOM element in the web page or which area of the web page is preferred by the user, and thus generate information regarding which area of the web page is preferred by the user.

For example, when the user usually selects a news area of a web page, the client may know that the user prefers the news area of the web page or DOM elements included in the news area of the web page, based on operations performed on coordinates of the news area by the user, such as clicking, zooming in and out, or scrolling.

According to an embodiment of the present disclosure, when the server selects an area of the web page according to the priority of the DOM elements, the server may select the area of the web page based on the performance information of the client. That is, when the server determines the priority of the DOM elements and determines DOM elements to be converted into an image, based on the performance information of the client, the server may determine the number of DOM elements or a size of the area to be converted into the image.

According to an embodiment of the present disclosure, the server may select an area of the web page such that DOM elements are included starting from a DOM element having a low priority according to the priority of the DOM elements. When the performance of the client is good, the server may select an area of the web page such that less DOM elements are included; when the performance of the client is poor, the server may select such that more DOM elements are included. The method of selecting an area of the web page is not limited to the example above. The server may select an area of the web page according to a policy stored in the server, a method set by the user, or the like.

According to an embodiment of the present invention, the server may prioritize the DOM elements according to the preference information of the client. In other words, Based on the preference information of the client, the server may prioritize such that a DOM element that is preferred by the user in the web page has a high priority. Alternatively, the server may prioritize in groups of areas of the web page.

According to an embodiment of the present disclosure, a priority may be determined depending on whether or not the DOM elements may interact. That is, when a DOM element may interact with the user, it may be determined that the DOM element has a high priority.

According to an embodiment of the present disclosure, the server may start converting the DOM elements into an image from a DOM element having a low priority.

In operation 303, the server converts the DOM elements in the area of the web page into an image.

According to an embodiment of the present disclosure, the server may select the DOM elements included in the area of the web page and convert the selected DOM elements into an image to be displayed on the web browser of the client. For example, the server may convert the selected DOM elements into an image by encoding the web page such that the selected DOM elements are displayed on the web browser of the client. As another example, when an area of the web page selected by the server is a news area, the server may convert DOM elements in the news area into an image so that DOM data capacity is reduced. That is, areas other than the news area may be displayed as the web page by using DOM elements in the DOM data, and the news area may be displayed as the web page by using the converted image included in the DOM data.

According to an embodiment of the present disclosure, the DOM data may be reduced by using methods other than converting into an image, and upon reduction, transmitting the reduced DOM data. There may be various methods for reducing the amount of data when generating the DOM data. For example, the server may generate the DOM data by compressing, encoding, or converting the DOM elements such that the DOM data may be directly uploaded in the memory of the client without performing an additional computing process on the DOM data received in the client. In addition, text format DOM data may be converted into binary format DOM data, and provided to the client.

In operation 305, the server generates the DOM data such that an image converted in operation 303 is a last node.

According to an embodiment of the present disclosure, the DOM data may have a hierarchical structure as a tree structure. The tree structure includes points that are referred to as “nodes”. The server may generate the DOM data such that an image converted in operation 303 is the last node. The last node is a node to which no other node is connected (i.e., a node that does not have child nodes), and may be also referred to as a “leaf node”. According to an embodiment of the present disclosure, a size of the DOM data may be reduced by generating the DOM data such that the converted image is the last node.

According to an embodiment of the present disclosure, the DOM data may be generated according to the performance information of the client. That is, according to the OS of the client or the web browser used by the client, the DOM data may be generated such that the DOM data is appropriate for the client.

In addition, according to an embodiment of the present disclosure, when generating the DOM data, the server may request another server to generate the DOM data. For example, when a server has received a web page request but may not generate DOM data for the Android platform, the server may request another server to generate the DOM data for the Android platform.

According to an embodiment of the present disclosure, the DOM data may include information regarding structures, operations, properties, etc. of the elements of the web page. The elements of the web page indicate the DOM elements such as images, flash, or text.

In operation 307, the server transmits the DOM data generated in operation 305 to the client.

According to an embodiment of the present disclosure, the server transmits the DOM data to the client via the network. The client receives the DOM data and displays the web page based on the received DOM data.

FIG. 4 is a flowchart of providing the web browsing service from the client according to an embodiment of the present disclosure.

Referring to FIG. 4, in operation 401, from the server, the client may receive DOM data that includes a node in which an area of the web page that includes the DOM elements is converted into an image.

According to an embodiment of the present disclosure, the DOM data is generated by the server, and may include a node in which the DOM elements included in an area of the web page selected by the server are converted into an image.

According to an embodiment of the present disclosure, when the client requests for the web page, the client may transmit at least one of the performance information of the client and the preference information of the client to the server. Since the performance information and the preference information of the client are described with reference to FIG. 3, detailed description thereof is omitted.

According to an embodiment of the present disclosure, the DOM elements may be prioritized by the server. That is, the DOM elements may be selected according to a priority determined by the server.

According to an embodiment of the present disclosure, the priority may be determined based on the preference information of the client. Alternatively, the priority may be determined based on whether or not the DOM elements may interact. That is, when a DOM element may interact with the user, it may be determined that the DOM element has a high priority.

In operation 403, the client displays the web page by using the DOM data.

According to an embodiment of the present disclosure, since the client appropriately receives the DOM data according to the performance information of the client, the client may display the web page on the web browser by using the received DOM data.

In operation 405, when the client receives a user's input that requests for one of the DOM elements, the client may send a request for additional DOM data to the server. In detail, when the client receives a user's input that requests for a DOM element from among the DOM elements that are converted into an image, the client may request the server to transmit additional DOM data that is configured of the DOM element requested by the user's input.

According to an embodiment of the present disclosure, the client receives the DOM data that includes the node in which the DOM elements are converted into an image. That is, since the client receives the DOM data in which the DOM elements are converted into an image, the DOM data does not include the DOM elements.

According to an embodiment of the present disclosure, the client may need DOM elements to change a web page display according to a user's input such as zooming in, zooming out, or scrolling. Therefore, when the client needs information regarding the DOM elements that are converted into an image so as to change the web page display according to the user's input, the client may request the server to transmit additional DOM data that is configured of the DOM elements. That is, based on the received DOM data and the user's input, the client may determine whether it is possible to change the web page display without sending a request to the server.

According to an embodiment of the present disclosure, when the client has already received a DOM element regarding a certain area of the web page, the client does not request the server to transmit additional DOM data, but may independently change the web page display according to the user's input. However, when the client receives a user's input that requests for one of the DOM elements that are converted into an image, the client may request the server to transmit additional DOM data. Also, when the web page needs to be newly displayed, the client may send a request to the server for information regarding the web page.

For example, when DOM elements included in a lower right area of the web page are converted into an image by the server, DOM elements in an upper left area of the web page are included in DOM data received by the client. Therefore, even when the client receives a user's input on the upper left area, such as zooming in and out, changing font size, or changing font, the client may independently process the user's input. Therefore, the client does not have to request the server to transmit additional DOM data.

However, the DOM data received by the client may include only the image of the lower right area of the web page. Therefore, the client may not independently process the user's input for the lower right area and has to request the server to transmit additional DOM data that includes DOM elements of the lower right area.

According to an embodiment of the present disclosure, the additional data that includes the DOM elements may include DOM elements that are converted into an image.

According to an embodiment of the present disclosure, the server may generate and transmit the additional DOM data requested by the client, according to operations 301 to 307 of FIG. 3.

According to an embodiment of the present disclosure, the client may receive the additional DOM data from the server and display the web page based on DOM data that is previously received and the additional DOM data.

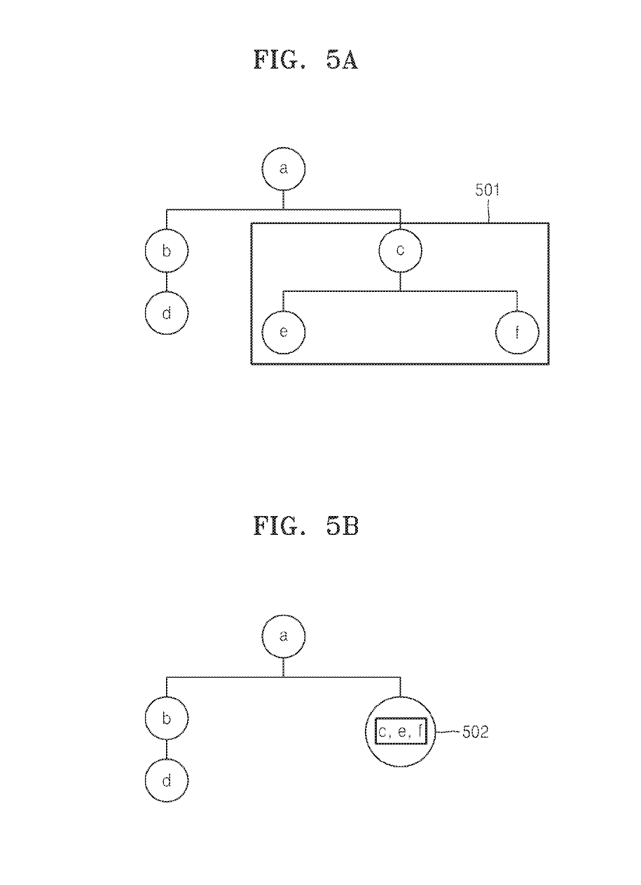

FIGS. 5A and 5B illustrate a structure of the DOM data according to an embodiment of the present disclosure.

As described with reference to FIGS. 2 to 4, according to an embodiment of the present disclosure, the DOM data may have a hierarchical structure as a tree structure. The nodes in the tree structure may indicate the points in the structure of the hierarchical DOM data, where predetermined DOM elements exist.

According to an embodiment of the present disclosure, the DOM elements may indicate the elements that form the web page (e.g., images, text, links, fonts, or frames). However, the DOM elements are not limited to the examples above.

Referring to FIG. 5A, the DOM data includes DOM elements “a”, “b”, “c”, “d”, “e”, and “f”, and the DOM elements may exist at each node.

According to an embodiment of the present disclosure, “a” is a root node, “b” and “c” are parent nodes, and “d”, “e”, and “f” are child nodes, but this may differ depending on the tree structure. For example, if there is an additional node under the “f” node, “f” is a parent node.

According to an embodiment of the present disclosure, the DOM elements may be referred to as nodes. That is, a node may be referred to as a DOM element existing at that node, and may be referred to as either a “node” or a “DOM element” depending on an expression method.

Referring to FIG. 5B, according to an embodiment of the present disclosure, when the server prioritizes the DOM elements and changes areas corresponding to the DOM elements “c”, “e”, and “f” into an image, the DOM data is converted into a form where “c”, “e”, and “f” are included in the DOM data as an image, and there are no additional nodes below the “c”, “e”, and “f”. That is, the “c”, “e”, and “f” may be last nodes (i.e., leaf nodes).

According to an embodiment of the present disclosure, the server receives the web page resource information from the web server. The server may parse the received web page resource information, and thus generate the DOM data. The server may select an area of the web page based on the generated DOM data and the priority of the DOM elements, restructure the DOM data by converting the DOM elements included in the selected area as an image, and thus transmit the restructured DOM data to the client.

According to an embodiment of the present disclosure, the client may receive the DOM data as shown in FIG. 5A. As described with reference to FIGS. 2 to 4, the server may transmit the DOM data in which the DOM elements are not converted into an image.

According to an embodiment of the present disclosure, the client may receive the DOM data that includes the node in which the DOM elements are converted into an image as shown in FIG. 5B. The client displays the web page based on the received DOM data. When the client receives a user's input regarding the DOM elements “c”, “e”, and “f” that are converted into an image 502, the client may request for the DOM elements “c”, “e”, and “f”. According to the client's request, the server transmits additional DOM data including DOM elements “c”, “e”, and “f” 501 of FIG. 5A. The client processes the user's input based on the received additional DOM data.

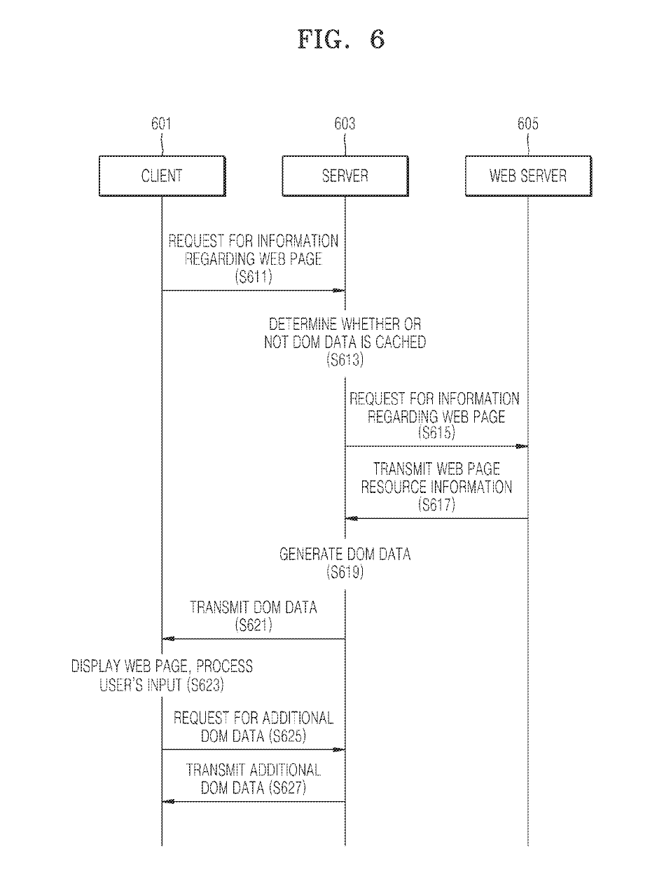

FIG. 6 is a flowchart of processing information for providing a web browsing service according to an embodiment of the present disclosure.

Referring to FIG. 6, in operation S611, a client 601 sends a request for information regarding the web page to a server 603. The information regarding the web page is for displaying the web page in the client 601 and includes resource information such as DOM data and HTML.

According to an embodiment of the present disclosure, along with the request for the information regarding the web page, the client 601 may transmit at least one of the performance information and the preference information of the client. Since the performance information and the preference information of the client are described with reference to FIGS. 2 to 4, detailed description thereof will be omitted.

In operation S613, the server 603 determines whether or not the DOM data is cached. That is, before sending a request to a web server 605 for the information regarding the web page, the server determines whether the DOM data requested by the client 601 is cached or not. If the DOM data is cached, the server 603 does not send the request for the information regarding the web page to the web server 605 and transmits the cached DOM data to the client 601.

According to an embodiment of the present disclosure, even when another client sends a request for information regarding the web page, the server 603 may determine whether or not the DOM data is cached and transmit the DOM data to the client when the DOM data is cached. That is, without having to generate new DOM data every time, the server 603 may transmit the cached DOM data according to repeated requests for the web page. In particular, even when various users are using the web browsing service in a cloud network, the server 603 may transmit the cached DOM data when there are repeated requests for a predetermined web page.

In operation S615, the server 603 sends a request for the information regarding the web page to the web server 605.

In operation S617, the web server 605 transmits the web page resource information to the server 603.

According to an embodiment of the present disclosure, the web page resource information is resource information for displaying the web page, and may include information that form the web page, such as HTML, JS, CSS, or images. However, the web page resource information is not limited to the examples above.

In operation S619, the server 603 generates DOM data.

According to an embodiment of the present disclosure, the server 603 may select an area of the web page, convert DOM elements that are included in the selected area of the web page into an image, and generate DOM data such that the converted image is a last node.

According to an embodiment of the present disclosure, the server 603 may prioritize the DOM elements, and select an area of the web page according to the priority of the DOM elements.

According to an embodiment of the present disclosure, the server 603 may select an area of the web page such that DOM elements are included starting from a DOM element having a low priority according to the priority of the DOM elements.

According to an embodiment of the present disclosure, the priority may be determined according to the preference information of the client 601, or alternatively, whether or not the DOM elements may interact.

In operation S621, the server 603 transmits the DOM data generated in operation S619 to the client 601.

In operation S623, the client 601 displays the web page and processes the user's input based on the received DOM data.

In operation S625, the client 601 requests the server 603 to transmit additional DOM data.

According to an embodiment of the present disclosure, in a case where a portion of the DOM data received by the client 601 has been converted into an image, as described with reference to FIG. 5B, when a user's input that requests for the DOM elements included in the area of the web page that is converted as an image is received, the client 601 requests the server 603 to transmit the additional DOM data. That is, since some of the DOM elements in the DOM data have been converted into an image, the DOM elements that have been converted into the image are not included in the DOM data that is received by the client 601. Therefore, in order to process the user's input regarding the area of the web page that is displayed as an image, the client 601 may request the server 603 to transmit the additional DOM data.

In operation S627, the server 603 transmits the additional DOM data to the client 601.

According to an embodiment of the present disclosure, the additional DOM data indicates DOM data that is configured of the DOM elements in the area of the web page that is converted into an image.

According to an embodiment of the present disclosure, the additional DOM data may be generated in the server 603.

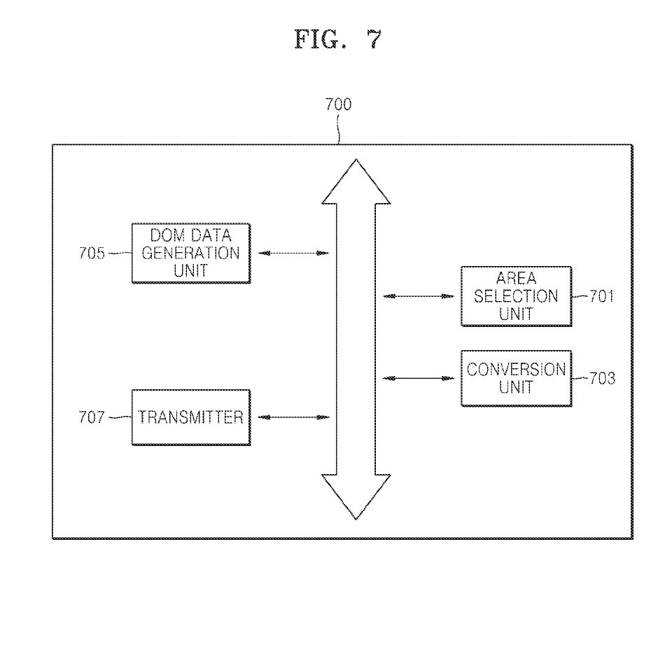

FIG. 7 illustrates a structure of a server 700 providing a web browsing service according to an embodiment of the present disclosure.

Referring to FIG. 7, the server 700 according to an embodiment of the present disclosure includes an area selection unit 701, a conversion unit 703, a DOM data generation unit 705, and a transmitter 707.

According to an embodiment of the present disclosure, the area selection unit 701 selects an area of a web page that is requested by the client.

According to an embodiment of the present disclosure, the area selection unit 701 may select the area of the web page according to resource information that is for displaying the web page received from the web server, or according to DOM data generated based on the resource information.

According to an embodiment of the present disclosure, the area selection unit 701 may include a prioritization unit (not shown) that prioritizes the DOM elements.

According to an embodiment of the present disclosure, the prioritization unit may prioritize the DOM elements according to the preference information of the client.

According to an embodiment of the present disclosure, the prioritization unit may prioritize the DOM elements according to whether or not the DOM elements may interact.

According to an embodiment of the present disclosure, the area selection unit 701 may select an area of the web page such that DOM elements are included starting from a DOM element having a low priority according to the priority of the DOM elements.

According to an embodiment of the present disclosure, the conversion unit 703 converts the DOM elements included in the area of the web page that is selected by the area selection unit 701 into an image. Alternatively, the conversion unit 703 may convert the DOM elements in the area of the web page into a plurality of images.

According to an embodiment of the present disclosure, the conversion unit 703 may compress, encode, or convert the DOM elements such that the DOM data may be directly uploaded in the memory of the client without performing an additional computing process on the DOM data. For example, the conversion unit 703 may convert DOM data that includes text format DOM elements into binary format DOM data.

According to an embodiment of the present disclosure, the DOM data generation unit 705 generates the DOM data such that the image converted in the conversion unit 703 is a last node. The DOM data may be generated based on the web page resource information received by the web server. That is, the DOM data generation unit 705 may generate any type of DOM data based on the web page resource information.

According to an embodiment of the present disclosure, the transmitter 707 may transmit the DOM data generated in the DOM data generation unit 705 to the client.

According to an embodiment of the present disclosure, when another client requests for the web page, the transmitter 707 may transmit generated DOM data or cached DOM data to the other client.

According to an embodiment of the present disclosure, the server may further include a caching unit that may cache the generated DOM data.

According to an embodiment of the present disclosure, the server may further include a receiver that receives data from the client or another server. The receiver may receive the request for the web page, the performance information of the client, the preference information of the client, etc., from the client.

According to an embodiment of the present disclosure, the elements of the server 700 may be connected via an internal bus or a controller (not shown).

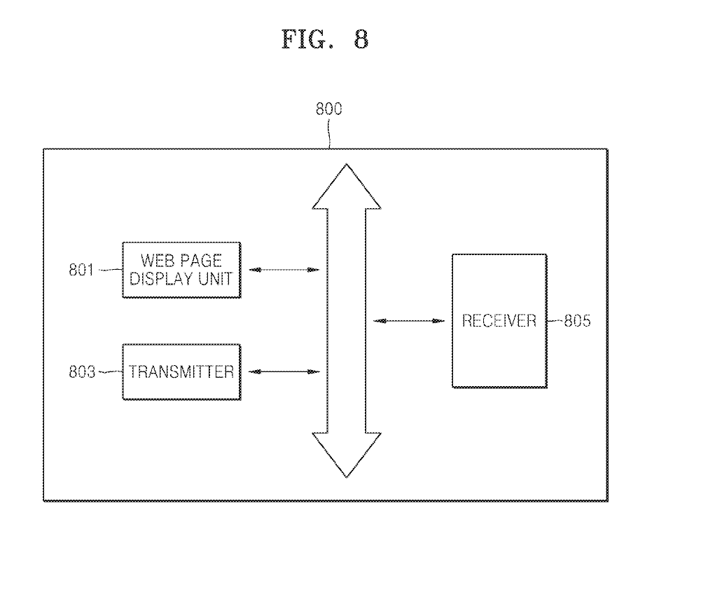

FIG. 8 illustrates a structure of a client 800 providing the web browsing service according to an embodiment of the present disclosure.

According to an embodiment of the present disclosure, the client 800 may include a web page display unit 801, a transmitter 803, and a receiver 805.

According to an embodiment of the present disclosure, the web page display unit 801 may display the web page by using the DOM data that is transmitted by the server. The web page display unit 801 may include a rendering unit that renders and displays the web page by using the DOM data.

According to an embodiment of the present disclosure, the web page display unit 801 may determine whether or not to request for additional DOM data. That is, the web page display unit 801 may display the web page by using the DOM data that includes a node in which the DOM elements are converted into an image. When a user's input that requests for the DOM elements included in the node, which are converted into an image, is received, the web page display unit 801 may send a request for additional DOM data by using the transmitter 803.

According to an embodiment of the present disclosure, the transmitter 803 may determine whether or not to request for the additional DOM data.

According to an embodiment of the present disclosure, the node that is converted into an image does not include the DOM elements. Only an image that may display the area of the web page is included in the DOM data. Since the client 800 needs the DOM elements to process the user's input, the client 800 may request the server to transmit additional DOM data that includes DOM elements that are not converted into an image. In some various embodiments, the additional DOM data may also include a node that is converted into an image. That is, the server may generate additional DOM data by converting at least one DOM element in a part of the web page into an image.

According to an embodiment of the present disclosure, the transmitter 803 may request the server to transmit the additional DOM data. In addition, based on the user's input, the transmitter 803 may request the server for information for displaying the web page.

According to an embodiment of the present disclosure, the transmitter 803 may transmit at least one of the performance information of the client or the preference information of the client to the server. According to an embodiment of the present disclosure, the performance information may include information regarding the performance of the client, and the preference information may include information regarding which area of the web page or which DOM element from among the DOM elements in the web page is preferred by the user.

According to an embodiment of the present disclosure, the receiver 805 may receive the DOM data from the server and receive the additional DOM data if necessary.

According to an embodiment of the present disclosure, the receiver 805 may receive web page resource information that is not DOM data from the server.

According to an embodiment of the present disclosure, the client 800 may include a user interface that receives the user's input. The client 800 may receive the user's input regarding the web page and request for additional DOM data if necessary via the user interface.

In addition, other various embodiments of the present disclosure may also be implemented through computer-readable code/instructions in/on a medium (e.g., a computer-readable medium), to control at least one processing element to implement any above-described embodiment. The medium may correspond to any medium/media permitting the storage of the computer-readable code.

The computer-readable code may be recorded on a medium in a variety of ways, with examples of the medium including recording media, such as magnetic storage media (e.g., ROM, floppy disks, hard disks, etc.) and optical recording media (e.g., CD-ROMs, DVDs, etc.). Thus, the medium may be such a defined and measurable structure including or information, according to one or more various embodiments of the present disclosure. Furthermore, the processing element could include a processor or a computer processor, and processing elements may be distributed and/or included in a single device.

It should be understood that the various embodiments described therein should be considered in a descriptive sense only and not for purposes of limitation. Descriptions of features or aspects within each embodiment should typically be considered as available for other similar features or aspects in other various embodiments.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of providing a web browsing service, the method comprising:
receiving, from a server, Document Object Model (DOM) data that comprises a node in which an area of a web page comprising a plurality of DOM elements is converted into an image;
displaying the web page by using the DOM data; and
requesting for additional DOM data that is configured of the DOM element, when a user's input that requests for a DOM element of the plurality of DOM elements is received.

2. The method of claim 1, further comprising, along with a request for the web page from the client, transmitting at least one of performance information of the client or preference information of the client to the server.

3. The method of claim 1, wherein the plurality of DOM elements are selected according to a priority determined in the server.

4. The method of claim 3, wherein the priority is determined in the server according to preference information of the client.

5. The method of claim 3, wherein the priority is determined depending on whether the plurality of DOM elements may interact.

6. The method of claim 1, wherein the DOM data is generated according to performance information of the client.

7. The method of claim 5, wherein the performance information of the client comprises at least one of Operating System (OS) information of the client, web browser information of the client, and model information of the client.

8. A method of providing a web browsing service, the method comprising:
selecting an area of a web page that is requested by a client;
converting Document Object Model (DOM) elements comprised in the area of the web page into an image;
generating DOM data, the generated DOM data includes the image as a last node; and
transmitting the DOM data to the client.

9. A server for providing a web browsing service, the server comprising:
an area selection unit configured to select an area of a web page that is requested by a client;
a conversion unit configured to convert Document Object Model (DOM) elements comprised in the area of the web page into an image;
a DOM data generation unit configured to generate DOM data, the generated DOM data includes the image as a last node; and
a transmitter configured to transmit the DOM data to the client.

10. The server of claim 9, further comprising:
a caching unit configured to cache the DOM data,
wherein when another client requests for the web page, the transmitter transmits the cached DOM data to the other client.

11. A client for providing a web browsing service, the client comprising:
a receiver configured to receive, from a server, Document Object Model (DOM) data that comprises a node in which an area of a web page comprising a plurality of DOM elements is converted into an image;
a web page display unit configured to display the web page by using the DOM data; and
a transmitter configured to request additional DOM data that is configured of the DOM element, when a user's input that requests for a DOM element of the plurality of DOM elements is received.

12. The client of claim 11, wherein the transmitter transmits at least one of performance information of the client or preference information of the client to the server, along with a request for the web page from the client.

13. The client of claim 11, wherein the plurality of DOM elements are selected according to a priority determined in the server.

14. The client of claim 13, wherein the priority is determined in the server according to preference information of the client.

15. The client of claim 13, wherein the priority is determined depending on whether the plurality of DOM elements may interact.

16. The client of claim 11, wherein the DOM data is generated according to performance information of the client.

17. The client of claim 12, wherein the at least one of performance information of the client comprises at least one of Operating System (OS) information of the client, web browser information of the client, and model information of the client.

18. The client of claim 11, further comprising:
requesting the server transmit additional DOM data that includes DOM elements that are not converted into an image.

19. A non-transitory computer-readable recording medium having recorded thereon a program, which, when executed by a computer, performs the method of claim 1.

20. A non-transitory computer-readable recording medium having recorded thereon a program, which, when executed by a computer, performs the method of claim 8.
